(19) United States
(12) Patent Application Publication
(10) Pub. No.: US 2009/0104301 A1
(43) Pub. Date: Apr. 23, 2009

(54) DEVICE FOR MELT SPINNING OF A LINEAR FILAMENT BUNDLE

(75) Inventors: Volker BIRKHOLZ, Neumunster (DE); Henning RAVE, Achterwehr (DE)

Correspondence Address: BAINWOOD HUANG & ASSOCIATES LLC, 2 CONNECTOR ROAD, WESTBOROUGH, MA, 01581, US

(73) Assignee: OERLIKON TEXTILE GMBH & CO. KG, Remscheid (DE)

(21) Appl. No.: 12/268,146

(22) Filed: Nov. 10, 2008

Related U.S. Application Data
(63) Continuation of application No. PCT/EP2007/004181, filed on May 11, 2007.

(30) Foreign Application Priority Data
May 11, 2006 (DE) 10 2006 021 909.0

(51) Int. Cl. B28B 17/00

(52) U.S. Cl. 425/198

(57) ABSTRACT

A device for melt spinning a linear filament bundle has a spinning shaft for mounting a longitudinal spinning nozzle group, having a nozzle plate including a plurality of nozzle openings on a bottom, and an inlet plate having at least one inlet channel on a top. A distribution chamber is provided between the inlet plate and the nozzle plate, which is connected to the inlet channel in the inlet plate and the nozzle openings in the nozzle plate. The inlet plate has multiple inlet channels provided at a distance to one another in longitudinal direction of the spinning shaft. Multiple distribution chambers arranged next to one another are provided in longitudinal direction of the spinning shaft. The inlet channels each end in one of the distribution chambers.

### CROSS REFERENCE TO RELATED APPLICATIONS

This patent application is a Continuation of International Patent Application No. PCT/EP2007/004181 filed on May 11, 2007, entitled, “DEVICE FOR MELT SPINNING OF A LINEAR FILAMENT BUNDLE”, the contents and teachings of which are hereby incorporated by reference in their entirety.

### FIELD OF INVENTION

Embodiments of the invention relate to a device for melt spinning of a linear filament bundle.

### BACKGROUND

It is known for the production of nonwovens that a plurality of fine filament strands, or elongated fibers are extruded in a linear arrangement. For this purpose elongated spinning nozzle groups are utilized, which are held in a heated spinning shaft. The spinning nozzle groups comprise a nozzle plate on an underside containing a plurality of nozzle openings for the extrusion of the filament strands. In order to feed the polymer melt supplied from a melt source to the nozzle openings, various solutions are known according to prior art.

A spinning nozzle bundle is known from EP1 486 591 A1, wherein the polymer melt supplied from the melt source is fed to an inlet plate via an inlet channel, and is guided into a distribution chamber. From the distribution chamber the polymer melt reaches the nozzle openings of the nozzle plate via a perforated plate. For this purpose the distribution chamber extends substantially across the entire length of the nozzle bundle. However, such systems generally have the disadvantage that only limited widths of nonwoven products can be produced. Great differences in residence times of the melt occur in larger production widths above 4 m in the polymer distribution, which result in changes of the melt, and therefore to the creation of irregularities with the extrusion of the filaments, which also occur due to changed physical properties of the filament strands.

In order to avoid such disadvantages, a device for melt spinning of a linear filament bundle is known from U.S. Pat. No. 6,220,843, in which the spinning nozzle group is modularly divided into several partial pieces. For this purpose the filament bundle is formed by individual filament groups, which can be extruded independently of each other. The spinning nozzle group has one inlet channel and one distribution chamber per module, in order to supply the group of nozzle openings associated with the distribution chamber. For this purpose each module is utilized in order to extrude through the group of nozzle openings by means of filament strands, wherein each group of filament strands can be extruded independently of adjacent groups of filament strands.

### SUMMARY

Although large production widths may be achieved in the production of nonwovens with a modular division of the spinning nozzle group by means of combining a plurality of groups of filament strands, the disadvantage is that melt differences occur at the extruded groups of filament strands, which may have different effects on the physical properties of the extruded groups of filament strands. In this regard, a production of a uniform filament bundle is not ensured across the entire production width of a nonwoven.

It is an object of the invention of further improving a device for melt spinning of a linear filament bundle of the generic type such that the filament bundle can be extruded for large production widths having substantially equal physical properties. Another goal of the invention is to produce a device of the type named above such that a residence time of the melt is obtained when extruding a linear filament bundle, which is as constant as possible.

This object is solved according to the invention in that the inlet plate comprises multiple inlet channels next to each other, provided at a distance in the longitudinal direction of the spinning shaft, and that multiple distribution chambers arranged next to each other are provided in the longitudinal direction of the spinning shaft, wherein the inlet channels each terminate in one of the distribution channels.

Characteristics and combinations of the certain features define advantageous and further improvements in accordance with particular embodiments of the invention.

The invention has the particular advantage that the melt must pass through relatively short distances within the nozzle group in order to be distributed to the nozzle openings. In this regard, a constant residence time of the melt can also be achieved within the spinning nozzle group using very large production width having respectively broad feathered filament bundles. Depending on the size and number of distribution chambers an inclined distribution of the melt within the spinning nozzle group is limited to a permissible degree.

A further improvement of the invention in which a collection chamber is connected upstream of the nozzle openings in the nozzle plate, the collection chamber being connected to the distribution chambers, is of particular advantage for melt spinning a uniform filament bundle. An evening out of the melt streams discharged by the distribution chambers occurs directly before extruding the melt. In this manner, the entire filament bundle can be extruded under equal conditions from the polymer melt provided through the nozzle openings, particularly under equal pressure conditions.

In order to uniformly distribute the polymer melt within the spinning nozzle group and feed the same to the linearly arranged nozzle openings, a perforated plate having a plurality of openings is arranged between the inlet plate and the nozzle plate according to an advantageous further improvement of the invention, wherein the openings in the perforated plate are arranged in multiple opening arrays, wherein one of the opening arrays is associated with the distribution chambers opposite of the inlet channels. In this manner, a distribution of the melt within the spinning nozzle group that is adjusted to the arrangement of the nozzle opening can be obtained. Furthermore, pressure increases may be affected by means of the size and arrangement of the openings within the perforated plate, which improve the extrusion process.

For this purpose it is advantageous if the collection chamber is provided between the perforated plate and the nozzle plate such that the openings in the set of openings may mutually lead into the collection chamber.

In order to achieve a separation between the individual distribution chambers the further improvement of the invention is preferably provided such that the perforated plate on a surface facing the inlet plate has a separating bar between each set of openings, and that the distribution chambers are formed in the bottom of the inlet plate between the separating bars. Furthermore, a high stability can be obtained within the spinning nozzle group, even with larger production widths.

The design of the device according to the invention, wherein the openings penetrate the perforated plate at an incline in the region of the separating bars such that a uniform distribution of openings is present across the surface of the perforated plate on the bottom opposite of the perforated plate, has the particular advantage that a uniform distribution of the melt, particularly into the adjacent collection chamber, is achieved despite of the separation of the distribution chamber.

For filtering the polymer melt of the spinning nozzle group the invention recommends to associate one of the multiple filter elements to each distribution chamber opposite of the inlet channels so that the filter elements each form an outlet of the filter chamber, and simultaneously lead to a filtration of the melt. For this purpose, the filter elements are preferably associated with the set of openings on the upper side of the perforate plate in order to facilitate easy handling.

In order to press the polymer melt through the nozzle openings of the nozzle plate at an overpressure that is as constant as possible, multiple spinning pumps are associated with the inlet channels in the inlet plate, which are supplied via a melt source. For this purpose an inlet channel or a group of inlet channels may each be associated with one spinning pump.

In order to achieve residence times that are as uniform as possible during the feeding of the polymer melt from the melt source to the spinning pumps, a manifold system having multiple branching points is switched between the melt source and the spinning pumps.

When producing nonwovens it is possible to produce the individual filaments of the filament bundle of two or more melt components, such as a core/coat fiber. In such cases the further improvement of the invention is preferably utilized, wherein the inlet channels are divided into two groups, each being associated with two groups of distribution chambers. For this purpose, a first group of distribution chambers interacts with a first perforated plate, and a second group of distribution chambers interacts with a second perforated plate, each having multiple groups of openings. The melt streams of the distribution chambers and perforated plates separately guided within the spinning nozzle group can now be supplied to the nozzle openings in the separating system, such as a distribution plate.

In these cases the groups of the inlet channels in the inlet plate are connected to at least two melt sources, wherein the inlet channels are fed by one spinning pump each.

The further improvement of the invention, wherein the spinning nozzle group within the spinning shaft has such a length that the filament bundle can be uniformly produced at a width of >5 m for forming a nonwoven, can be advantageously utilized in order to achieve large production widths and thus a higher productivity with the production of nonwovens.

In order to obtain a sufficiently uniform residence time for the guiding of the melt within the spinning nozzle group with very large production widths, the distribution chambers are preferably provided according to a further embodiment of the invention such that they have a maximum length extension of <700 mm, preferably <500 mm within the spinning nozzle group. Therefore, the melt distribution extended in the longitudinal direction of the spinning shaft is limited during the feeding of the melt.

However, it is also possible according to a further improvement of the invention to assemble multiple spinning nozzle groups linearly to one spinning length such that the filament bundle can be combined to a width of >5 m for forming a nonwoven. In this manner, production widths of more than 10 m are possible for the production of nonwovens.

The device according to the invention is preferably used in order to produce spun nonwovens from one filament bundle. However, it is also possible to extrude fiber nonwovens according to the so-called melt blown principle using the device according to the invention. In these cases the spinning nozzle group is combined with a blowing nozzle on the outlet side.

### BRIEF DESCRIPTION OF THE DRAWINGS

The invention is described in further detail below based on some example embodiments of the device according to the invention, making reference to the attached figures.

They show:

FIG. 1 which is a schematic view of a first example embodiment of the device according to the invention,

FIG. 2 which is a schematic longitudinal view of an example embodiment of a spinning nozzle group,

FIG. 3 which is a schematic cross-sectional view of the spinning nozzle group of FIG. 2,

FIG. 4 which is a schematic top view onto a perforated plate of the spinning nozzle group according to FIG. 2,

FIG. 5 which is a schematic longitudinal sectional view of another example embodiment of a spinning nozzle group,

FIG. 6 which is a schematic cross-sectional view of another example embodiment of a spinning nozzle group,

FIG. 7 which is a schematic view of another example embodiment of the device according to the invention, and

FIG. 8 which is a schematic longitudinal sectional view of another example embodiment of a spinning nozzle group.

### DETAILED DESCRIPTION

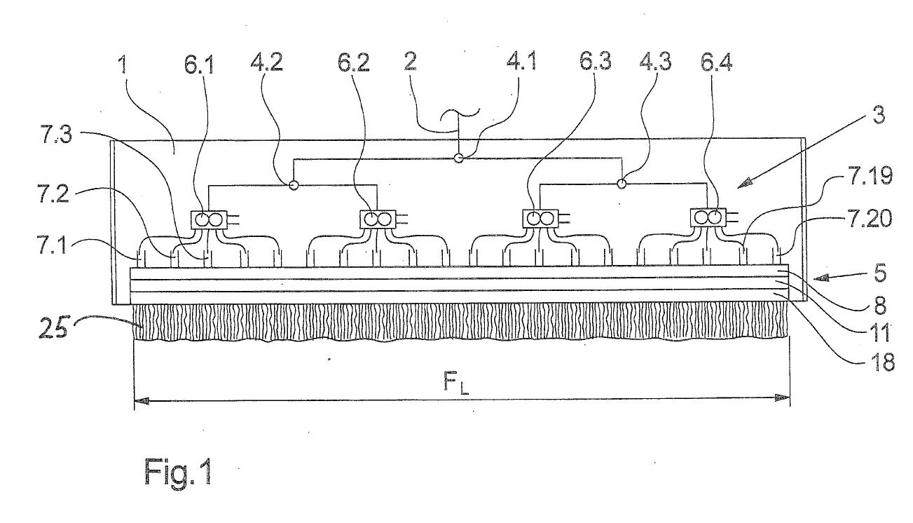

FIG. 1 illustrates a first example embodiment of the device according to the invention in a schematic view. The example embodiment shows a longitudinal spinning shaft 1 for mounting a longitudinal spinning nozzle group 5, which is arranged on the bottom of the spinning shaft 1. The spinning nozzle group 5 is constructed in the shape of plates, and has an upper inlet plate 8, a center perforated plate 1, and a lower nozzle plate 18. The embodiment of the spinning nozzle group 5 and the embodiment of the plates 8, 11, and 18 is illustrated and explained in further detail below.

The spinning nozzle group 5 is connected to multiple spinning pumps 6.1, 6.2, 6.3, and 6.4 via multiple melt lines 7.1, 7.2, 7.3, etc. Multiple melt lines are associated with the spinning pumps 6.1 to 6.3, which are directly associated with the inlet plate 8. In this example embodiment a total of five melt lines are associated with each spinning pump 6.1 to 6.4.

A manifold system 3 is arranged within the spinning shaft in order to connect the spinning pumps 6.1 to 6.4 to a melt source that is not illustrated. For this purpose the polymer melt provided by a melt source, such as an extruder, is fed to the manifold system via a melt line 2. The manifold system has multiple branching points 4.1, 4.2, and 4.3 in order to connect the melt line 2 to the spinning pumps 6.1 to 6.4.

The spinning shaft 1 can be heated so that the components carrying the melt within the spinning shaft 1 have a predetermined operating temperature. The heating us usually carried out by means of a heat transfer medium that is introduced into the container-shaped spinning shaft. Alternatively, the spinning shaft 1 may also be heated by electric heating means.

In the operating state a polymer melt is fed to the spinning shaft 1 via a melt source by means of the melt line 2. The polymer melt is guided to the individual spinning pumps 6.1 to 6.2 via the manifold system 3, the branching points 4.1, 4.2, 4.3. The spinning pumps 6.1 to 6.4 are each driven at an equal operating speed such that partial melt streams are created at equal pressure and fed to the spinning nozzle group 5 via the connected melt lines 7.1 to 7.20. The partial streams of the polymer melt are combined in the spinning nozzle group 5, and pressed through nozzle openings in the nozzle plate 18. A linear filament bundle 25 is created in this manner. The filament bundle 25 is produced at a production width that is referenced by the letter F_{L} in FIG. 1. The filament bundle produced within the production width F_{L} is deposited as a nonwoven on a nonwoven repository by means of additional processing assemblies not illustrated herein.

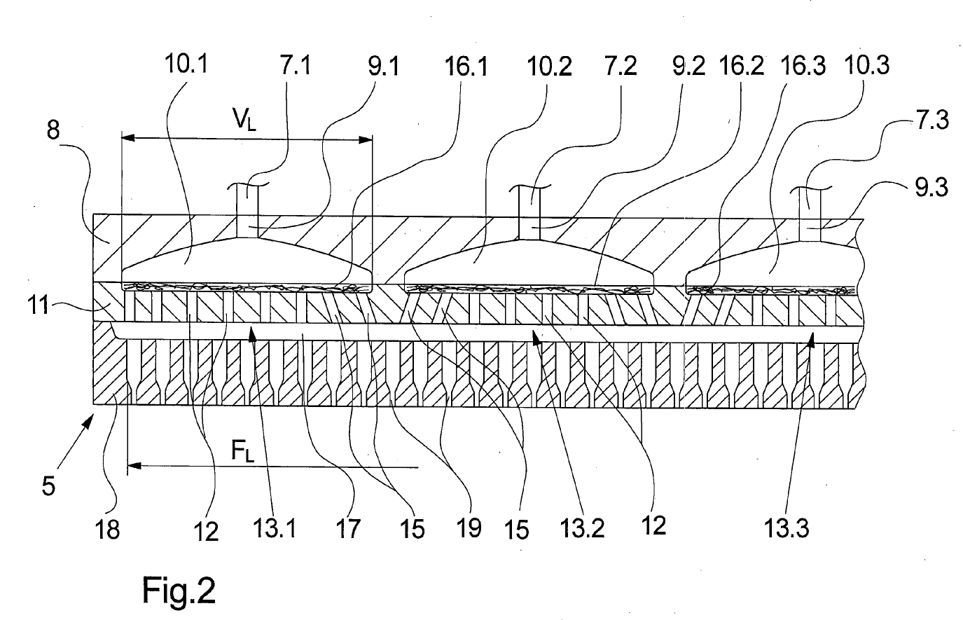

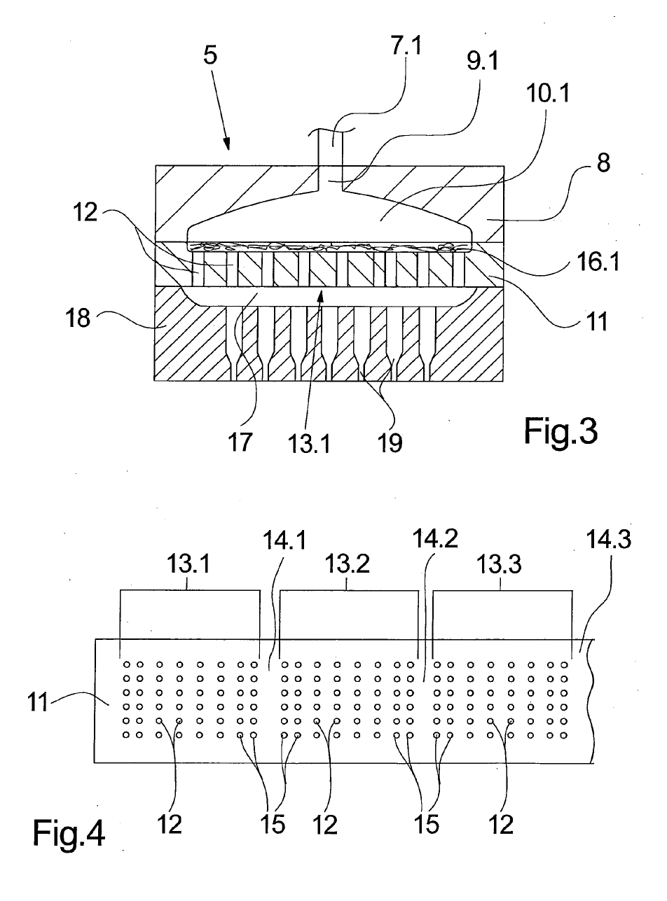

In order to obtain a uniform extrusion of the filament strands and a uniform quality of the filament strands across the entire production width F_{L} the filament strands are guided and distributed within the spinning nozzle group 5 via the spinning pumps 6.1 to 6.4 and the melt lines 7.1 to 7.20 according to a certain distribution pattern. FIGS. 2 and 3 illustrate an example embodiment of such a spinning nozzle group 5. FIG. 2 shows the spinning nozzle group 5 in a longitudinal sectional view, and FIG. 3 shows it schematically in a cross-sectional view. If no express reference is made to one of the figures, the following description applies to both figures.

The spinning nozzle group is comprised of an upper inlet plate 8, a center perforated plate 11, and a lower nozzle plate 18, which are connected to each other, for example, via a screw fitting. Multiple inlet channels arranged at a distance to one another are incorporated in the inlet plate, which are directly connected to one of the melt lines 7.1 to 7.20. FIG. 2 illustrates only the first three inlet channels 9.1, 9.2, and 9.3, since the construction thereof is redundant.

Each of the inlet channels 9.1, 9.2, and 9.3 ends in a distribution chamber 10.1, 10.2, and 10.3. The distribution chambers 10.1, 10.2, and 10.3 are formed by one recess in the bottom of the inlet plate 8. The distribution chambers 10.1 and 10.2 are arranged next to each other at a narrow distance in the longitudinal direction of the spinning nozzle group 5.

A perforated plate 11 is provided adjacent to the bottom in the inlet plate 8, which has one group of openings 13.1, 13.2, and 13.3 per distribution chamber 10.1, 10.2, and 10.3. Each of the groups of openings 13.1, 13.2, and 13.3 comprises a plurality of openings 12, which penetrate the perforated plate 11 up to the bottom thereof.

FIG. 4 shows a top view of the perforated plate 11 for reasons of explanation of the arrangement of the group of openings within the perforated plate 11. In this regard the following description of the perforated plate 11 also applies to the arrangement illustrated in FIG. 4. Opening arrays 13.1, 13.2, and 13.3 are separated from one another on the top of the perforated plate 11 by means of separating bars 14.1 and 14.2. As the view in FIG. 2 shows, the separating bars 14.1 and 14.2 form a separation between the individual distribution chambers 10.1, 10.2, and 10.3 together with the bottom of the inlet plate 8.

The openings in the perforated plate 11 adjacent to the separating bars 14.1 and 14.2 are provided as inclined openings 15, and penetrate the perforated plate 11 at an angle of <90°. The opening rows associated with the separating bars 14.1 or 14.2 have openings having different inclines, which penetrate the perforated plate 11. The inclination of the inclined openings 15 in the region of the separating bars 14.1 and 14.2 are selected such that a uniform distribution of openings extending across the entire surface of the perforated plate 11 is created on the bottom of the perforated plate 11. The melt streams being discharged from the distribution chambers 10.1, 10.2, and 10.3 are evened out via the openings 12 and the inclined openings 15 of the perforated plate 1 exit on the bottom of the perforated plate 11 in this manner.

One filter element 16.1, 16.2, and 16.3 is held on the top of the perforated plate 11 per array 13.1, 13.2, and 13.3. The filter element 16.1 is designed such that the free surface formed on the bottom of the inlet plate 8 is covered by the distribution chamber 10.1 such that the filter element 16.1 forms the outlet of the distribution chamber 10.1. The filter element 16.2 is adjusted to the distribution chamber 10.2 accordingly.

The nozzle plate 18 is provided adjacent to the bottom of the perforated plate 11. The nozzle plate 18 has a collection chamber 17 on the top, which extends across the entire production width such that the individual partial melt streams of the distribution chambers 10.1, 10.2, 10.3 mutually enter into the collection chamber 17 via the group of openings 13.1, 13.2, 13.3, etc. A plurality of nozzle openings 19 in the nozzle plate 18 is associated with the collection chamber 17. The nozzle openings 19 are provided in one or more rows, and extend across the entire production width F_{L}.

In order to obtain residence times that are as constant as possible in the embodiment of the distribution of the melt illustrated in FIG. 2, it has been shown that the longitudinal extension of the distribution chambers 10.1, 10.2, 10.3, etc., should not exceed certain regions, if possible. The longitudinal extension of the distribution chamber 10.1 is denoted with the reference symbol V_{L} in this example embodiment. In order to obtain productions widths that are as large as possible, such as >5 m at an optimum of melt distribution, a longitudinal extension of the distribution chamber in a range of max. 700 mm to preferably a maximum of 500 mm has been proven as particularly favorable. However, it is generally also possible to realize larger or smaller longitudinal extensions in the distribution chambers.

In the operating state, one polymer melt is fed to the spinning nozzle group 5 via the melt line 7.1 to 7.20 illustrated in FIG. 1. The polymer melt enters into the respectively connected distribution chambers 10.1, 10.2, 10.3, etc. via the melt channels 9.1, 9.2, 9.3 in order to exits via the associated filter element 16.1, 16.2, and 16.3. Subsequently, the partial melt streams are guided and combined in the collection chamber 17 via the opening arrays 13.1, 13.2, and 13.2 of the perforated plate 11. An evening out of the supplied partial melt streams occurs in the collection chamber 17 such that the polymer melt contained in the collection chamber 17 is continuously received via the connected nozzle openings 19 within the nozzle plate 18, and extruded into the individual filaments. Residence times that are particularly brief and constant across the length of the spinning shaft 5 are therefore obtained with the guiding of the melt such that no decomposition or changes of the melt can occur.

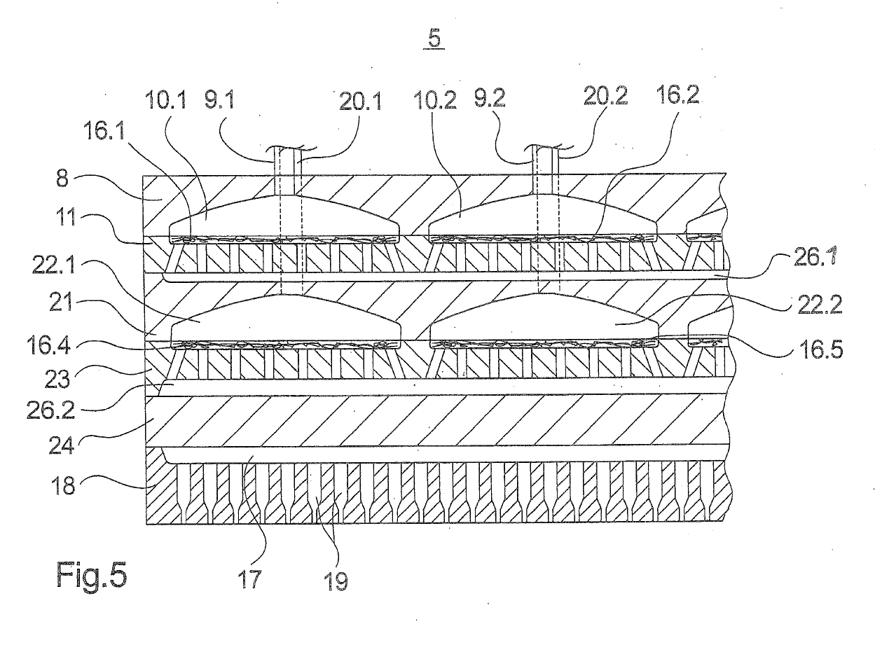

The device according to the invention is suited to extrude a linear filament bundle from a polymer melt. However, it is also possible to provide multiple melt types in so-called Bico fibers, for example, by means of two separate melt sources, and to extrude the same to multi-component fibers. For this purpose FIG. 5 schematically illustrates an example embodiment of a spinning nozzle group, as could be utilized, for example, for the production of a core/coat fiber. The components having the same functions are supplied with identical reference symbols, wherein the structural embodiment may show differences compared to the previously stated example embodiment.

The spinning nozzle group 5 is formed of multiple plates, which individually comprise an inlet plate 8, a perforated plate 11, a dosing plate 21, a second perforated plate 23, a distribution plate 24, and a nozzle plate 18. The inlet plate 8 comprises a first group of distribution chambers 10.1, 10.2, etc., which are connected to melt lines via a first group of inlet channels 9.1, 9.2, etc. The plate 11 is associated with the inlet plate 8 on the bottom, wherein each perforated plate 11 has an opening array 13.1, 13.2, etc. for each distribution chamber 10.1, 10.2, etc. A filter element 16.1, 16.2, etc. is held at the top of the perforated plate 11 for each opening array 13.1, 13.2, etc., by means of which the openings of the opening array 13.1, 13.2, etc. are covered.

A dosing plate 21 is arranged below the perforated plate 11, which forms a distribution chamber 26.1 on the top thereof, and has openings that are not illustrated herein. A second group of distribution chambers 22.1, 22.2, etc., which is coupled to melt lines via a second inlet channel group 20.1 and 20.2, is provided on the bottom of the dosing plate 21. The second group of inlet channels 20.2 is introduced into the inlet plate 18, and extends through the perforated plate up to the second group of distribution chambers 22.2 in the dosing plate 21. The second group of inlet channels is connected to a second melt source by means of melt lines and spinning pumps.

A second perforated plate 23 is arranged below the dosing plate 21, which also has multiple opening groups 13.1, 13.2, and 13.3 in order to distribute the polymer melt discharged from the distribution chamber 22.1, 22.2, etc. Another filter element 13.4 is arranged between the distribution chamber 22.1 and the opening array 13.1, and a further filter element 16.5 is arranged between the distribution chamber 22.2 and the second opening array 13.2. The opening arrays of the second perforated plate 23 end in a second distribution chamber 26.2, which is disposed above the distribution plate 24. Furthermore, the perforated plate 23 has through holes in order to guide the first melt component guided from the distribution chamber 26.1 to the distribution plate 24 arranged below the second perforated plate 23. The distribution plate 24 has a distribution system, particularly formed by means of openings, holes and rivets, in order to guide both melt components to the nozzle openings 19 of the nozzle plate 18.

An important factor in the example embodiment illustrated in FIG. 5 is that the polymer melt fed to the spinning nozzle group 5 across the production width is guided by means of a plurality of partial streams on the inlet side. Each melt component is discharged into the spinning nozzle group via one distribution chamber each. A combining of the melt components is carried out directly before extruding through the nozzle openings. Short distances, and therefore short residence times of the melt are also achieved due to the melt guiding being aligned substantially horizontally.

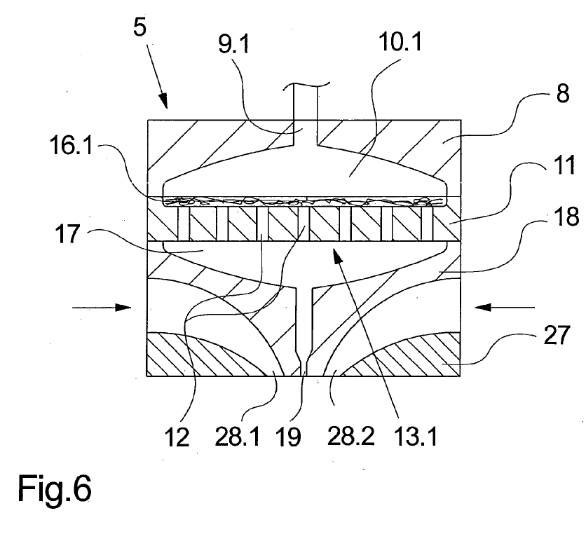

FIG. 6 shows a further example embodiment of a spinning nozzle group as could be utilized in the device illustrated in FIG. 1, for example. The example embodiment illustrated in a cross-sectional view in FIG. 6 shows a spinning nozzle group for producing a linear filament bundle according to the so-called melt blown process. For this purpose the nozzle group is comprised of an inlet plate 8, a perforated plate 11, a nozzle plate 18, and a blowing nozzle 27. The construction of the inlet plate 8, the perforated plate 11, and the nozzle plate 18 is substantially identical to the previously stated example embodiments according to FIGS. 2 and 3 so that reference is made at this point to the previously stated description, and only the differences will be explained below.

In the so-called melt blown process the fiber extruded through a nozzle opening is drawn off by means of a blowing stream during extruding. For this purpose a blowing nozzle 27 having blowing nozzle openings 28.1 and 28.2 ending in both sides of the nozzle opening is arranged on the bottom of the nozzle plate 18. The blowing nozzle openings 28.1 and 28.2 are connected to a compressed air source in order, for example, to supply a preferably tempered blowing air on the outlet side of the nozzle opening 19. For this purpose the nozzle plate 18 has a number of nozzle openings 19, which extend parallel to the slot-shaped blowing nozzle openings 28.1 and 28.2.

The melt feed is provided within the spinning nozzle group 5 according to the previously mentioned example embodiments so that the polymer melt fed into the collection chamber 17 is uniformly extruded through the nozzle opening 19.

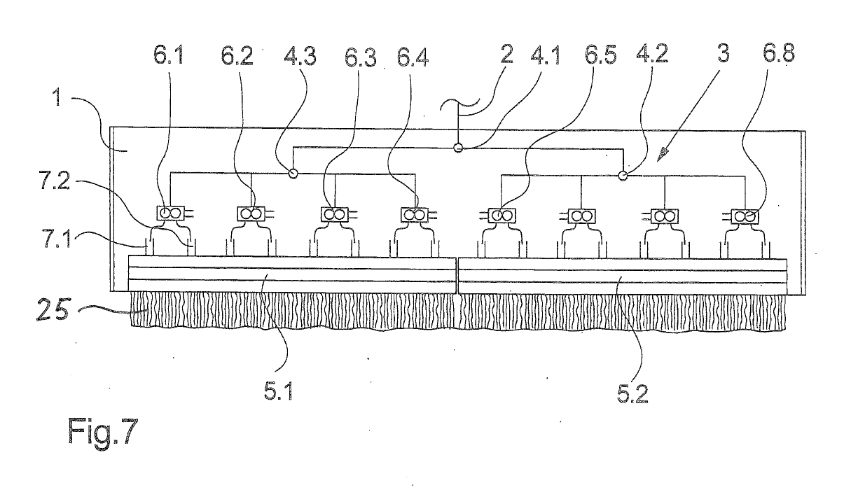

FIG. 7 shows a further example embodiment of the device according to the invention in a schematic view. The device has a spinning shaft 1, which holds spinning nozzle groups 5.1 and 5.2 that are arranged next to each other in longitudinal direction on the bottom 2. Each of the spinning nozzle groups 5.1 and 5.2 is provided identically, and could be provided, for example, by means of a spinning nozzle group according to FIG. 2, or FIG. 5, or FIG. 6.

Multiple spinning pumps 6.1, 6.2 to 6.8 are associated with each spinning nozzle group 5.1 and 5.2. For this purpose the spinning pumps 6.1 to 6.4 are associated with a first spinning nozzle group 5.1 and the spinning pumps 6.5 to 6.8 are associated with a second spinning nozzle group 5.2. Each of the spinning pumps 6.1 to 6.8 is coupled to the spinning nozzle group 5.1 or 5.2 via two melt lines. In this regard each of the spinning nozzle groups 5.1 and 5.2 has a total of eight inlet channels.

A manifold system 3 is associated with the two groups of spinning pumps 6.1 to 6.3 and 6.5 to 6.8 in order to connect all spinning pumps to a melt source. At this point it should be expressly noted, however, that each of the groups of spinning pumps may also be connected to one melt source, or to multiple melt sources by means of separate manifold systems.

The example embodiment of the device according to the invention illustrated in FIG. 7 is particularly suited in order to obtain large production width for the production of linear filament bundles. Production widths in the range of >10 m can be realized using such systems.

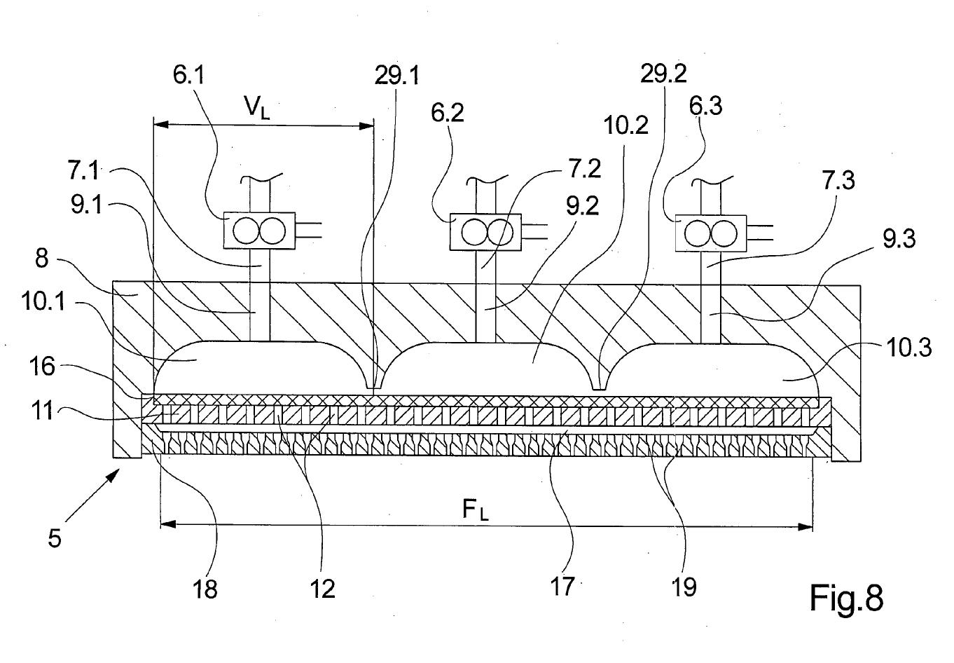

A further example embodiment of a spinning nozzle group 5 is illustrated in a longitudinal sectional view in FIG. 8. As already described regarding the previously stated example embodiments, the spinning nozzle group 5 is held in a longitudinal spinning shaft, and is tempered. Contrary to the currently shown example embodiments, the inlet plate 8 is provided as a carrier plate in the spinning nozzle group 5, on the bottom sides of which the perforated plate 11 and the nozzle plate 18 are held. In such an embodiment the inlet plate 8, for example, can be integrated into the spinning shaft 1 in a fixed manner. Alternatively, however, the inlet plate 8 can be provided as an exchangeable unit both with the nozzle plate 18 and with the perforated plate 11.

Multiple inlet channels 9.1, 9.2, and 9.3 that are arranged at a distance to each other are introduced in the inlet plate 8, which are directly connected to one of the multiple spinning pumps 6.1, 6.2, and 6.3 via a melt line 7.1, 7.2, and 7.3. Each of the inlet channels 9.1, 9.2, and 9.3 ends in a distribution chamber 10.1, 10.2, and 10.3. The distribution chambers 10.1, 10.2, and 10.3 are each formed by a recess on the bottom of the inlet plate 8.

A perforated plate 11 is provided adjacent to the bottom of the inlet plate 8, which has a plurality of openings 12 connecting the top of the perforated plate to the bottom of the perforated plate 11. A filter element 16 is held on the top of the perforated plate 1, which directly illustrates the lower limitation of the distribution chambers 10.1, 10.2, and 10.3.

Recesses for forming individual distribution openings 29.1 and 29.2 are provided on the bottom of the inlet plate 8 in the transitional region between two adjacent distribution chambers 10.1 and 10.2, and the adjacent distribution chambers 10.2 and 10.3. The distribution openings 29.1 and 29.2 form a passage above the perforated plate 11 so that the distribution chambers 10.1, 10.2, and 10.3 are connected to each other. In this manner a pre-distribution of the individual partial melt streams induced into the distribution chambers 10.1 to 10.3 can be achieved before entering the collection chamber 17.

The filter element 16 held on the top of the perforated plate 11 therefore forms a mutual outlet of the distribution chambers 10.1, 10.2, and 10.3.

The nozzle plate 18 is provided adjacent to the bottom of the perforated plate 11. The nozzle plate 18 has a collection chamber 17 on the top, which extends across the entire production width such that the melt stream fed across the perforated plate 11 is evened out further. The polymer melt then reaches the nozzle openings 19 of the nozzle plate 18 from the collection chamber 17, which extend in one or more rows across the entire production width F_{L}.

In the example embodiment of the spinning nozzle group 5 illustrated in FIG. 8 the distribution chambers 10.1, 10.2, and 10.3 each extends across a longitudinal extension V_{L} oriented in the longitudinal direction of the spinning shaft. Depending on the production width F_{L}, the number of inlet channels and of the distribution chambers, and the longitudinal extension of the distribution chambers is selected such that a uniform melt stream is prevalent in the spinning nozzle group from the inlet up to the extruding of the filaments. For this purpose it is insignificant, whether the inlet plate 8 is provided as an integral part of the spinning nozzle group in an exchangeable manner, or whether it is provided as an integral part of the spinning shaft.

The example embodiments of the device according to the invention illustrated in FIGS. 1 to 8 serve as examples of the individual components with regard to their construction and their arrangement. The number of inlet channels and distribution chambers, and the elongated extension of the distribution chambers also serve as examples. Generally, the distribution chambers are to be selected with regard to their maximum production width such that the polymer melt can be guided at short distances and short residence times within the spinning shaft so that a uniform production of nonwovens made of extruded fibers of equal consistency can be produced across the entire production width.

List of Reference Symbols

| | |
|---|---|
| 1 | spinning shaft |
| 2 | melt feed |
| 3 | manifold system |
| 4.1, 4.2, 4.3 | branching point |
| 5, 5.1, 5.2 | spinning nozzle group |
| 6.1, 6.2, 6.3 | spinning pump |
| 7.1, 7.2, 7.3 | melt line |
| 8 | inlet plate |
| 9.1, 9.2, 9.3 | inlet channel |
| 10.1, 10.2, 10.3 | distribution chamber |
| 11 | perforated plate |
| 12 | opening |
| 13.1, 13.2, 13.3 | opening groups |
| 14 | separating bar |
| 15 | inclined opening |
| 16, 16.1, 16.2, 16.3 | filter element |
| 17 | collection chamber |
| 18 | nozzle plate |
| 19 | nozzle openings |
| 20.1, 20.2 | inlet channel group |
| 21 | dosing plate |
| 22.1, 22.2 | distribution chamber |
| 23 | second perforated plate |
| 24 | distribution plate |
| 25 | filament bundle |
| 26.1, 26.2 | distribution room |
| 27 | blowing nozzle |
| 28.1, 28.2 | blowing nozzle opening |
| 29.1, 29.2 | distribution openings |

What is claimed is:

1. A device for melt spinning a linear filament bundle having a spinning shaft for mounting a longitudinal spinning nozzle group, having a nozzle plate including a plurality of nozzle openings on a bottom, and an inlet plate having at least one inlet channel on a top,
wherein a distribution chamber is provided between the inlet plate and the nozzle plate, which is connected to the inlet channel in the inlet plate and the nozzle openings in the nozzle plate,
wherein the inlet plate has multiple inlet channels provided at a distance to one another in longitudinal direction of the spinning shaft,
wherein multiple distribution chambers arranged next to one another are provided in longitudinal direction of the spinning shaft, and
wherein the inlet channels each end in one of the distribution chambers.

2. The device according to claim 1, wherein a collection room is connected upstream of the nozzle openings in the nozzle plate, which is connected to the distribution chambers.

3. The device according to claim 2, wherein a perforated plate having a plurality of openings is arranged between the inlet plate and the nozzle plate,
wherein the openings are arranged in multiple opening groups in the perforated plate, and
wherein one of the opening groups is associated to the distribution chambers opposite of the inlet channels.

4. The device according to claim 3, wherein the collection chamber connected to the nozzle openings is provided between the perforated plate and the nozzle plate, and
wherein the openings of the opening groups mutually end in the collection chamber.

5. The device according to claim 3, wherein the perforated plate has a separating bar on a top facing the inlet plate between the opening groups, and
wherein the distribution chambers are formed in the bottom of the inlet plate between the separating bars.

6. The device according to claim 5, wherein the openings penetrate the perforated plate at an incline in the region of the separating bars such that a uniform distribution of openings is present across the surface of the perforated plate on the opposite bottom of the perforated plate.

7. The device according to claim 1, wherein one of multiple filter elements each is associated with the distribution chambers opposite of the inlet channels, and
wherein the filter elements each form an outlet of the distribution chamber.

8. The device according to claim 1, wherein the inlet channels in the inlet plate are connected to a melt source, and
wherein one of multiple spinning pumps is associated with each of the inlet channels or a group of inlet channels.

9. The device according to claim 8, wherein a manifold system having multiple branching points is arranged between the melt source and the spinning pumps.

10. The device according to claim 1, wherein the inlet channels are divided into two groups,
wherein two groups of distribution chambers are associated with the inlet channels,
wherein a first group of distribution chambers is provided having multiple opening groups between the inlet plate and a first perforated plate, and the second group of distribution chambers is provided having multiple opening groups between a dosing plate and a second perforated plate.

11. The device according to claim 10, wherein a distribution plate having a distribution system is connected upstream of the nozzle plate, by means of which the opening groups of both perforated plates are connected to the nozzle openings of the nozzle plate.

12. The device according to claim 10, wherein the groups of the inlet channels in the inlet plate are connected to two melt sources, and
wherein one of multiple spinning pumps is arranged on each of the inlet channels.

13. The device according to claim 1, wherein the spinning nozzle group within the spinning shaft has a length such that the filament bundle can be uniformly produced on a production width (F_{L}) of >5 m for forming a nonwoven.

14. The device according to claim 13, wherein the distribution chambers within the spinning nozzle group have a maximum longitudinal extension (V_{L}) of <700 mm, preferably lower than 500 mm.

15. The device according to claim 1, wherein multiple spinning nozzle groups are assembled linearly to one spinning length within the spinning shaft such that the filament bundles can be combined on a production width (F_{L}) of >5 meters for forming a nonwoven.

16. The device according to claim 1, wherein the distribution chambers adjacent to one another are combined with each other by means of at least one distribution opening.
